(19) United States
(12) Patent Application Publication
(10) Pub. No.: US 2003/0028504 A1
(43) Pub. Date: Feb. 6, 2003

(54) Method and system for isolating features of defined clusters

(76) Inventors: David A. Burgoon, Columbus, OH (US); Steven W. Rust, Worthington, OH (US); Owen C. Chang, Columbus, OH (US); Loraine T. Sinnott, Columbus, OH (US); Stuart J. Rose, Richland, WA (US); Elizabeth G. Hetzler, Kennewick, WA (US); Lucille T. Nowell, Richland, WA (US)

Correspondence Address: Woodard, Emhardt, Naughton, Moriarty and McNett, Bank One Center/Tower, 111 Monument Circle, Suite 3700, Indianapolis, IN, 46204-5137, US

(21) Appl. No.: 09/850,998

(22) Filed: May 8, 2001

(51) Int. Cl. G06F 7/00

(52) U.S. Cl. 707/1

(57) ABSTRACT

A cluster isolation system includes a processor that is operatively coupled to an input device, an output device, and memory. The system determines feature/interval combinations that distinguish one cluster of data objects from other clusters. The processor calculates cluster isolation measurement values at selected cut-off values for each feature. The processor reports the features and feature score intervals that satisfy selected isolation measurement value thresholds.

### BACKGROUND OF THE INVENTION

The present invention generally relates to cluster isolation methods, and more specifically, but not exclusively, relates to techniques for identifying features from a collection of data objects that best distinguish one cluster of data objects from another cluster.

Data exploration/visualization technologies are used in a wide variety of areas for analyzing data. Such areas include document management and searching, genomics, bioinformatics, and pattern recognition. For document applications, this technology is often used to group documents together based on document topics or words contained in the documents. Data exploration/visualization can also be used to analyze gene sequences for gene expression studies, and identify relationships between features for pattern recognition, to name just a few other applications.

Many data exploration/visualization technologies consider generally a collection of “data objects.” The term “data object” (singular or plural form), as used herein, refers to a set of related features (including, quantitative data and/or attribute data). For example, a data object could be a document, and the set of features could include occurrence of words contained in the document or document topics. In another example, a data object could be a person in a study, and the set of features could include the sex, height and weight of that person. One goal of data exploration/visualization is to partition data objects into groups (clusters) in which data objects in the same group are considered more similar to each other than data objects from different groups. For the previous example where the data object is a person, cluster grouping could be based on sex.

Each data object is associated with an ordered vector, the elements of which can quantitatively indicate the strength of the relationship between the data object and a given feature, or can reflect the characteristics of the data object. Such data exploration/visualization technologies typically place data objects into clusters using the distance between vectors as a measure of data object similarity. This collection of data objects is then converted to a collection of clusters with a varying number of data objects assigned to each cluster, depending typically on the vector of each data object and the candidate clusters. Each feature can be quantitatively related to a data object by a score that indicates the strength of the relationship between the feature and the data object.

The clustered data objects being investigated can also be analyzed visually. In one data visualization technique, representations of data objects are plotted on a computer screen using a two dimensional projection of an n-space visualization in which “n” is the number of features being analyzed. Each feature defines an axis in the visualization, and in this n-space, data objects are plotted in relation to the feature axes. The data objects tend to cluster in this n-space so as to be visually distinguishable. The n-space combination of data objects and associated clusters are projected into a two-dimensional image (2-space) for viewing by an investigator.

Data exploration/visualization technologies consider the empirical distribution of the scores among the data objects. A feature can be informative of a cluster when the distribution of the feature scores for a specified cluster is distinguished from the distribution of the scores of data objects not in the specified cluster. During analysis of the clusters, it is often desirable to summarize what feature(s) distinguishes one set of clusters from another. Further, it is important to understand how one cluster is distinguished from another and what characterizes a cluster. Using the above example, the persons in the study may be clustered according to sex, and the weight of a person may be a feature that distinguishes males from females.

In classical bayesian or quadratic discrimination, all of the cluster results are used to classify a significant number of cluster members in order to attach distinguishing features to clusters. Although quadratic discrimination is scalable to cover relatively large data sets, quadratic discrimination is computationally complex. Further, quadratic discrimination often produces complex, discontinuous classification regions, and can make interpretation for the user quite difficult. Like quadratic discrimination, decision tree discrimination techniques, which produce comprehensive classification rules, are typically user intensive and computationally complex. Therefore, there has been a long felt need for a simple and user-friendly strategy to identify features and corresponding feature score intervals that distinguish clusters from one another.

### SUMMARY OF THE INVENTION

One form of the present invention is a unique method for identifying features that distinguish clusters of data objects with a computer system. Other forms concern unique systems, apparatus and techniques for identifying distinguishing cluster features.

In a further form, a number of items of a common type are selected for analysis. Each of the items is represented as a corresponding one of a number of data objects with a computer system, and the data objects are grouped into a number of clusters based on relative similarity. The clusters are evaluated with the computer system in order to distinguish a selected cluster. At least one limit is set, and the selected cluster is selected for evaluation. An interval of feature scores for a feature is selected, and the computer system determines that an inclusiveness value for the feature satisfies the limit and an exclusiveness value for the feature satisfies the limit. The inclusiveness value corresponds to a proportion of data objects from the selected cluster within the interval, and the exclusiveness value corresponds to a proportion of data objects from one or more other clusters outside the interval. The results are provided with an output device of the computer system.

In another form, a computer-readable device is encoded with logic executable by a computer system to distinguish a selected cluster of data objects. The computer system calculates for the selected cluster an inclusiveness value and an exclusiveness value for a feature. The inclusiveness value corresponds to a proportion of data objects from the selected cluster within the interval, and the exclusiveness value corresponds to a proportion of data objects from one or more other clusters outside the interval. The computer system provides results when the inclusiveness value and the exclusiveness value satisfy at least one limit.

In a further form, a data processing system includes memory operable to store a number of clusters of data objects that are grouped based on relative similarity. A processor is operatively coupled to the memory, and the processor is operable to distinguish a selected cluster. The processor calculates for the selected cluster an inclusiveness value and an exclusiveness value for a feature. The inclusiveness value corresponds to a proportion of data objects from the selected cluster within the interval, and the exclusiveness value corresponds to a proportion of data objects from one or more other clusters outside the interval. An output device is operatively coupled to the processor, and the output device provides results from the processor when the inclusiveness value and the exclusiveness value satisfy at least one limit.

Another form concerns a technique for visually distinguishing clusters of data objects. A number of items of a common type are selected for analysis. Each of the items is represented as a corresponding one of a number of data objects with a computer system. The data objects are grouped into a number of clusters based on relative similarity. A graph is generated on an output device of the computer system in order to distinguish a selected cluster. The graph includes a first portion proportionally sized to represent a quantity of data objects within an interval of feature scores for a feature and a second portion proportionally sized to represent a quantity of data objects outside the interval for the feature. The first portion includes a bar proportionally sized to represent a quantity of data objects from the selected cluster within the interval, and the second portion includes a bar proportionally sized to represent a quantity of data objects from the selected cluster outside the interval.

Other forms, embodiments, objects, features, advantages, benefits and aspects of the present invention shall become apparent from the detailed drawings and description contained herein.

### BRIEF DESCRIPTION OF THE DRAWINGS

FIG. 1 is a diagrammatic view of a system according to the present invention.

FIG. 2 is a flow diagram illustrating a routine for isolating characterizing features of clusters according to the present invention.

FIG. 3 is a first graph illustrating different cluster types.

FIG. 4 is a second graph illustrating different cluster types.

FIG. 5 shows a view of a threshold limit and cluster specification display screen for the system of FIG. 1.

FIG. 6 is a flow diagram illustrating one process for identifying distinguishing features and interval scores according to the present invention.

FIG. 7 is a two-feature cluster distribution graph illustrating a cluster visualization technique according to the present invention.

FIG. 8 is a cut-bar graph illustrating another cluster visualization technique according to the present invention.

FIG. 9 is a cluster pair cut-chart illustrating a further cluster visualization technique according to the present invention.

FIG. 10 is a multiple cluster cut-chart illustrating another cluster visualization technique according to the present invention.

FIG. 11 is a cut-graph illustrating a further cluster visualization technique according to the present invention.

### DESCRIPTION OF SELECTED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the art that some of the features which are not relevant to the invention may not be shown for the sake of clarity.

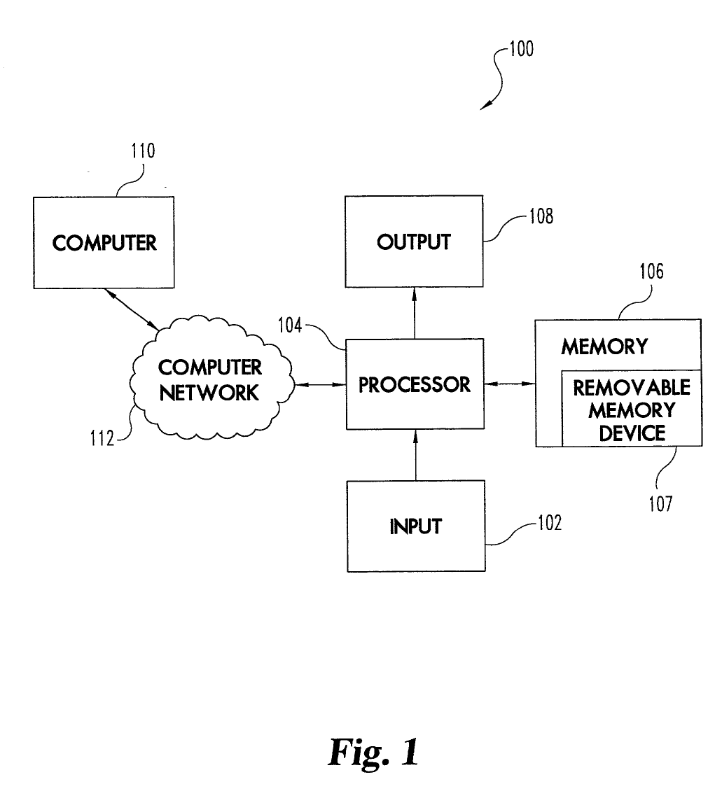

FIG. 1 depicts a computer system 100 according to one embodiment of the present invention in a diagrammatic form. The computer system 100 includes an input device 102, a processor 104, memory 106, and output device 108. Input device 102 is operatively coupled to processor 104, and processor 104 is operatively coupled to memory 106 and output device 108. In one form, input device 102, processor 104, memory 106, and output device 108 are collectively provided in the form of a standard computer of a type generally known to those skilled in the art. As shown, a computer 110 is also operatively coupled to the computer system 100 over a computer network 112. Input device 102 can include a keyboard, mouse, and/or a different variety generally known by those skilled in the art. The processor 104 may be comprised of one or more components. For a multi-component form of the processor 104, one or more components can be located remotely relative to the others, or configured as a single unit. Furthermore, processor 104 can be embodied in a form having more than one processing unit, such as a multiprocessor configuration, and should be understood to collectively refer to such configurations as well as a single-processor-based arrangement. One or more components of processor 104 may be of the electronic variety defining digital circuitry, analog circuitry or both. Processor 104 can be of a programmable variety responsive to software instructions, a hardwired state machine, or a combination of these. Memory 106 can include one or more types of solid state electronic memory, magnetic memory, or optical memory, just to name a few. Memory 106 includes removable memory device 107. Device 107 can be in the form of a nonvolatile electronic memory unit, an optical disc memory (such as a DVD or CD ROM); a magnetically encoded hard disc, floppy disc, tape, or cartridge media; or a combination of these memory types. The output device 108 can include a graphic display monitor, a printer, and/or a different variety generally known by those skilled in the art. The computer network 112 can include the Internet or other Wide Area Network (WAN), a local area network (LAN), a proprietary network such as provided by America OnLine, Inc., a combination of these, and/or a different type of network generally known to those skilled in the art. A user of the computer 110 can remotely input and receive output from processor 104. System 100 can also be located on a single computer or distributed over multiple computers.

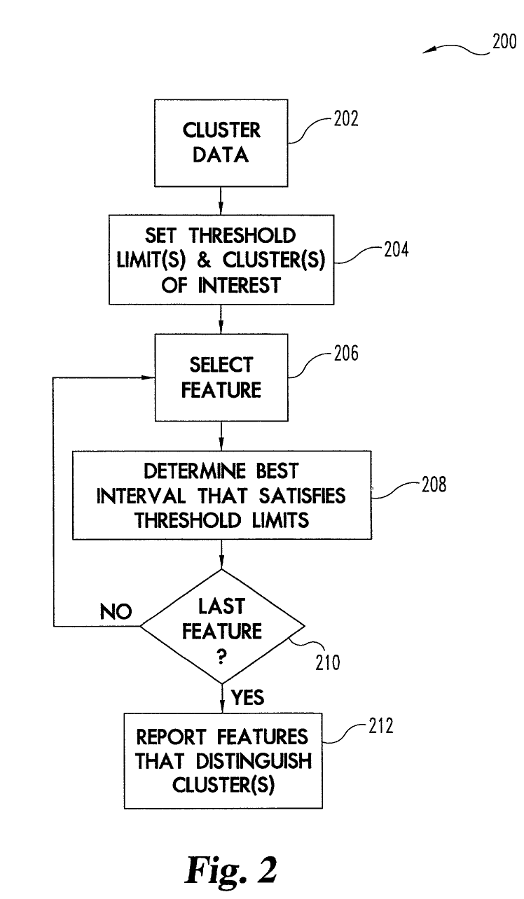

One routine for isolating characterizing features of clusters according to the present invention will now be described with reference to flow diagram 200 shown in FIG. 2. The processor 104 includes logic in the form of programming to perform the routine according to the present invention. In stage 202, the processor 104 clusters data objects in a manner as generally known by those skilled in the art and stores the clustered data information in memory 106. In one form, the clustered data objects represent amino acid triplets involved in the expression of genes as proteins. In another form, the clustered data objects represent a collection of documents, and the analyzed features are the relative occurrence of words in the documents. The clustered data can be displayed in a graphical form, tabular form, and/or in other forms generally known to those skilled in the art. It should be appreciated that the present invention can be used in other data clustering applications as would be generally known by those skilled in the art.

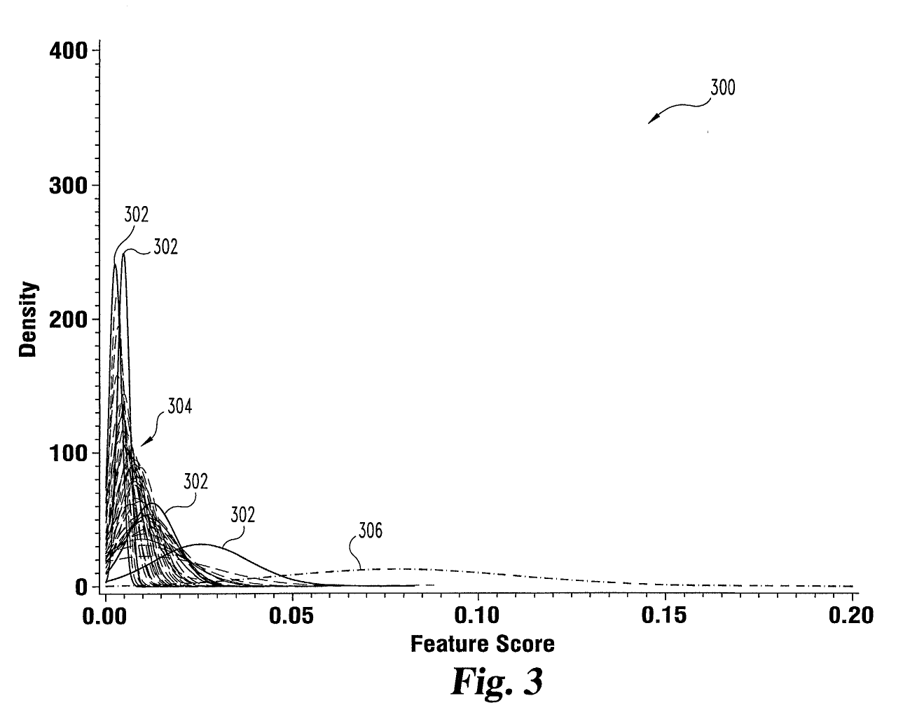

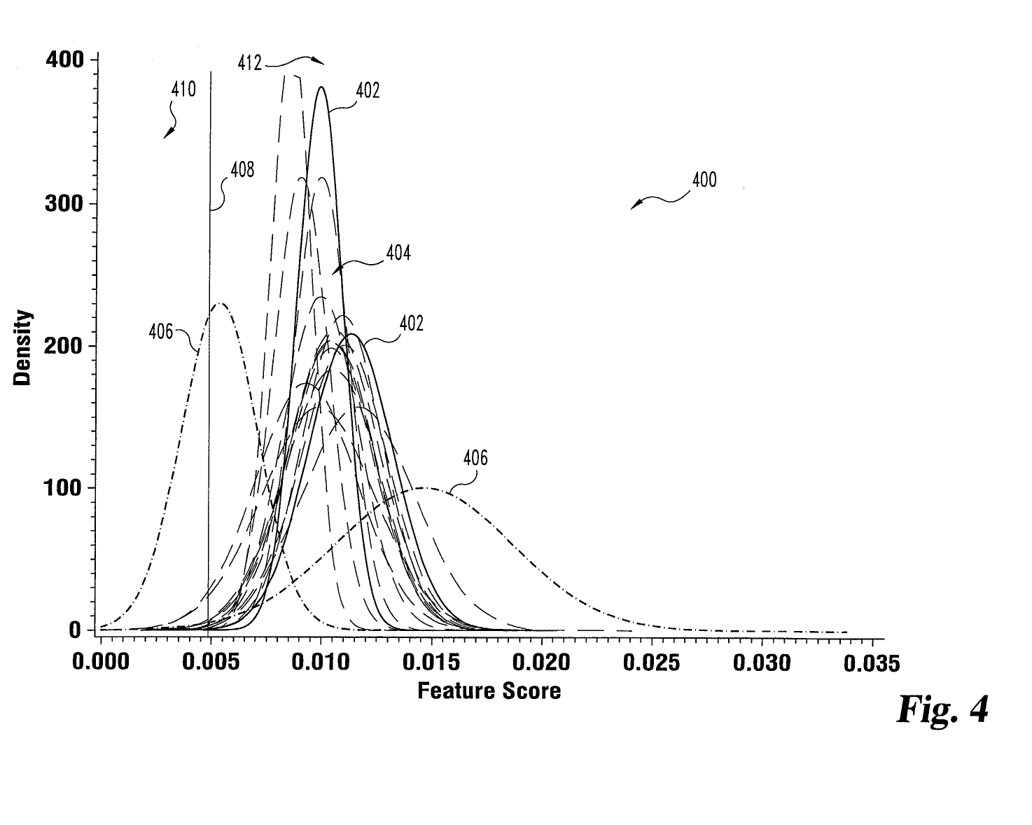

Referring additionally to FIG. 3 and FIG. 4, certain concepts concerning cluster characterization are further described. In FIG. 3, graph 300 represents the distribution of a particular topic (feature) for documents (data objects) within each of 50 clusters. The distributions of the clusters have been graphed for a particular feature. For plotting purposes, distributions of the scores for the particular feature were assumed normal (gaussian), with location and spread given by mean and standard deviation of the feature in the observed cluster. This approach allows a convenient and simple visualization of the distributions of feature scores across identified clusters. Graph 300 illustrates for a single feature the score distributions of the individual clusters. The vertical, “Density” axis represents the probability level, and the horizontal, “Feature Score” axis represents the feature score for the particular graphed feature. In graph 300, the feature score axis represents the relatedness of a particular document to a specific topic.

Graph 300 contains various cluster distribution curve types 302, 304, and 306. For this particular graphed topic, as is common with many features, it is difficult to distinguish numerous clusters from one another. The distributions of cluster curve types 304 crowd into the same score range. In the case of this particular topic, the “crowded” range has a feature score from 0.002 to 0.02. Even in this range, however, cluster curve type 302 stands out because there is a sizeable interval of the scores within which the curves of the clusters dominate the curves of all other clusters. Given a document with a score in this interval for the topic in question, it is most likely the document is a member of a dominating cluster. However, as shown, classifying a document as a member of a cluster based solely on the local dominance of a distribution may result in numerous misclassifications.

Like cluster curve type 302, the distribution of cluster curve type 306 dominates over a large interval of scores and is distinguishable from the other clusters. As shown, the bulk of the distribution of cluster curve type 306 is well removed from the bulk of the distribution of scores for most other clusters. Thus, a given document with a topic score level greater than 0.05 is most likely a member of cluster curve type 306. Furthermore, if a document with a score greater than 0.05 is classified as belonging to cluster curve type 306, this classification would seldom be wrong.

A second example is shown in FIG. 4. Graph 400 represents the distribution of 18 clusters for a particular feature. Graph 400 contains cluster curve types 402, 404 and 406. The feature distributions of cluster curve types 404 crowd into the same score range. Clusters of curve type 402 stand out because there is a sizeable interval of scores in which the represented clusters dominate the other clusters. As can be seen in FIG. 4, clusters of cluster curve type 406 stand out as having the bulk of their mass removed from the majority of the other clusters. One of these is at the lower end range of observed feature scores and the other, also indicated by reference number 406, is at the upper end of the range.

For each feature, a feature score range is divided into two intervals. These two intervals are based on a cut-off value 408, which is shown in FIG. 4. An interval with feature values to the left of the cut-off value 408 is referred to as a left interval 410, and an interval with feature values to the right of the cut-off value 408 is referred to as a right interval 412. In the FIG. 4 example, the left interval 410 includes values less than the cut-off value 408, and the right interval 412 includes values greater than the cut-off value 408. The left interval 410 and the right interval 408 can also alternatively include/exclude the cut-off value 408. For example, in one form, the left interval 410 includes values less than the cut-off value 408, and the right interval 412 includes values greater than or equal to the cut-off value 408. In another form, the left interval 410 includes values less than or equal to the cut-off value 408, and the right interval 412 includes values greater than the cut-off value 408.

As evident from the above discussion, there is a desire to measure how isolated a particular cluster is from the other clusters in order to find what feature(s) distinguish the clusters from one another. It is further desired that isolation measurements indicate: (1) the amount of inclusiveness of a particular cluster for a given feature score interval and (2) the exclusivity of a cluster in a particular feature score interval. These two isolation measurements are respectively referred to as the inclusiveness value and the exclusiveness value. Generally, the inclusiveness value measures the amount of inclusiveness of a selected cluster for a given feature/interval combination. The exclusiveness value generally measures the exclusivity of the selected cluster for the given feature/interval combination. Both the inclusiveness and exclusiveness values can be determined in reference to either the selected cluster or the particular interval. When the inclusiveness value is determined with reference to the selected cluster, the value is called sensitivity, and when determined with reference to the particular interval, the inclusiveness value is called positive predictive value. In comparison, the exclusiveness value that is determined with reference to the selected cluster is called specificity, and the exclusiveness value that is determined with reference to the particular interval is called negative predictive value.

As mentioned above, inclusiveness values can be subcategorized into sensitivity and positive predictive values. Sensitivity is calculated based on the number of data objects from the selected cluster while the positive predictive value is based on the number of data objects in a particular interval. More specifically, the sensitivity for a given feature is the ratio of the number of data objects from a selected cluster within an interval divided by the number of data objects from the selected cluster (Equation (1)). In comparison, the positive predictive value is the ratio of the number of data objects from the selected cluster within the interval divided by the number of data objects within the interval (Equation (2)).

$$\begin{matrix}Sensitivity = \frac{\begin{matrix}Number of Data Objects \\ ( Inside Interval \& Inside Cluster )\end{matrix}}{Number of Data Objects ( Inside Cluster )} & ( 1 ) \\ \begin{matrix}Positive \\ Predictive \\ Value\end{matrix} = \frac{\begin{matrix}Number of Data Objects \\ ( Inside Interval \& Inside Cluster )\end{matrix}}{Number of Data Objects ( Inside Interval )} & ( 2 )\end{matrix}$$

Exclusivity can be subcategorized into specificity and negative predictive value. Specificity is calculated based on the number of data objects from clusters other than the selected cluster while negative predictive value is based on the number of data objects outside a particular interval. In particular, the specificity for a given feature is the ratio of the number of data objects from other cluster(s) that are outside the interval divided by the number of data objects from the other clusters (Equation (3)). The negative predictive value is the ratio of the number of data objects from other clusters that are outside the interval divided by the number of data objects outside the interval (Equation (4)).

$$\begin{matrix}Specificity = \frac{\begin{matrix}Number of Data Objects \\ ( Outside Interval \& Outside Cluster )\end{matrix}}{Number of Data Objects ( Outside Cluster )} & ( 3 ) \\ \begin{matrix}Negative \\ Predictive \\ Value\end{matrix} = \frac{\begin{matrix}Number of Data Objects \\ ( Outside Interval \& Outside Cluster )\end{matrix}}{Number of Data Objects ( Outside Interval )} & ( 4 )\end{matrix}$$

High inclusiveness and exclusiveness values for an interval indicates that the selected cluster set dominates over the particular feature/interval combination. The inclusiveness and exclusiveness values can be used with the score intervals to find the features that distinguish clusters from one another. More specifically, the inclusiveness value can be used in characterizing the selected cluster, and the exclusiveness value can be used for distinguishing the selected cluster from the other clusters.

Referring again to FIG. 2, threshold limits for the sensitivity/specificity values along with predictive values are set in stage 204, and the cluster(s) of interest that need to be distinguished from the other clusters are also set in stage 204. The threshold limits are used to specify the minimum isolation measurement values that will distinguish a cluster. The clusters of interest (selected clusters) are the clusters that are going to be analyzed by processor 104 in order to determine distinguishing feature/interval combinations. Although the feature isolation method will be described below for a single cluster of interest, it should be appreciated that multiple clusters or all clusters can be specified as clusters of interest and analyzed at the same time.

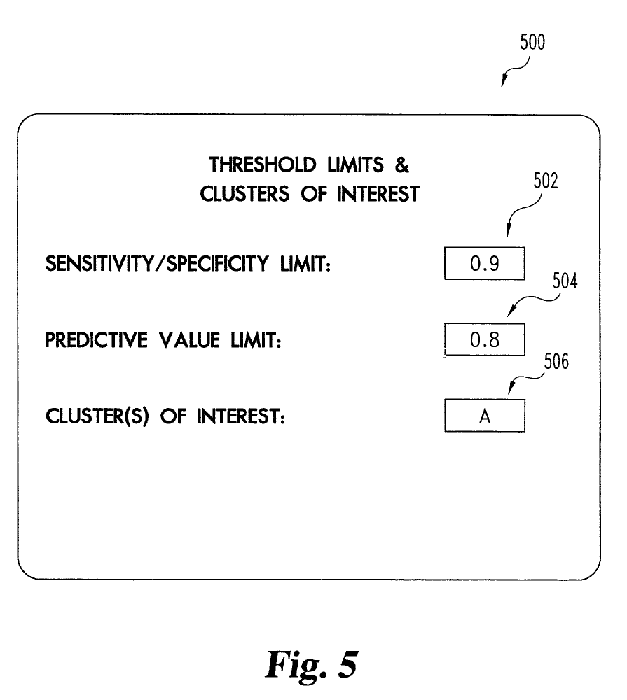

In one form of the present invention, predefined threshold limits and clusters of interest are automatically set by the processor 104. In a further form, the processor 104 automatically generates reports based on a series of predefined threshold limits. In another form, a person reviews the clustered data in a report, such as graphs 300 and 400, and selects clusters of interest based on the report. The person also selects the threshold limits. FIG. 5 illustrates an exemplary data entry screen 500 shown on output 108. A person enters the sensitivity/specificity threshold limit in field 502 and the desired predictive value threshold limit in field 504. The person enters into field 506 the cluster(s) the person wishes to have analyzed. It should be understood that other ways of entering information as would generally occur to those skilled in the art could be used. For example, the limits for specificity, sensitivity, positive predictive values and negative predictive values each could be separately specified or a single threshold limit could be specified in data entry screen 500. The threshold limits provide a simple user accessible strategy for identifying distinguishing features. The method of classification according to the present invention allows for a simple strategy of defining classification regions.

Table 1, below, will be referenced in order to explain the cluster isolation method according to the present invention.

TABLE 1

| Cluster | Data Object | Feature 1 | Feature 2 |
|---|---|---|---|
| A | 1 | 0.70 | 0.03 |
| | 2 | 0.80 | 0.03 |
| | 3 | 0.85 | 0.02 |
| B | 4 | 0.75 | 0.10 |
| | 5 | 0.60 | 0.15 |
| | 6 | 0.55 | 0.14 |
| | 7 | 0.55 | 0.12 |

Table 1 shows the separate data objects clustered into two clusters, A and B. In this exemplary embodiment, two features, Feature 1 and Feature 2, have been scored for the different data objects. The data objects in this example are different documents, and the features are different topics. The scores in the feature columns represent the relatedness of a particular document to a particular topic. In this example, the information contained in Table 1 is stored in memory 106.

Processor 104 iteratively analyzes each feature for the cluster of interest in order to determine the feature(s) and corresponding score interval(s) that best distinguish the individual clusters of interest. In stage 206 (FIG. 2), processor 104 selects one of the features for analysis. Processor 104 in stage 208 determines for the selected feature the best interval for the cluster of interest that satisfies the threshold limits for the selected feature. Next, processor 104 in stage 210 determines whether the last feature for analysis has been selected. If the last feature has not been selected for analysis, processor 104 selects the next feature in stage 206. Otherwise, processor 104 in stage 212 generates a report of feature(s) that distinguish the cluster of interest from the other clusters and sends the report to output device 104 so that the report can be reviewed.

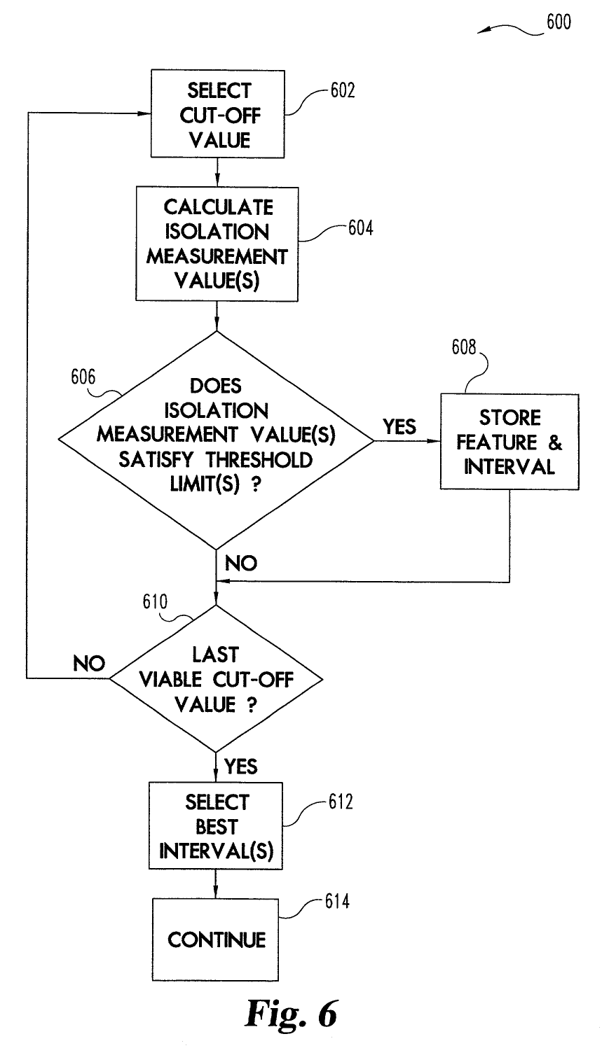

Flow diagram 600 in FIG. 6 illustrates a routine for determining the best interval by using isolation measurement values. Flow diagram 600 will be generically used to describe the routines used in stage 208. In one form, the isolation measurement values are calculated separately for each interval (left and right), and in another form, the isolation measurement values for each interval are simultaneously calculated. In stage 602, processor 104 selects an initial cut-off value that is used to determine the interval. In one form of the invention, processor 104 selects the cut-off value based upon actual scores within a particular cluster and feature. Basing the cut-off values on actual data object scores results in retrieval of optimum cut-off valves. Using the Table 1 example, the processor 104 would first select a cut-off value of 0.70 (data object 1, feature 1) in order to calculate the first isolation measurement values for feature 1. In another form, the cut-off values are selected based on a grid of predefined cut-off values stored in memory 106. Basing the cut-off values on a grid allows for control over processing times of processor 104. The intervals in still yet another form can be manually entered by a person. In addition, Boolean operators can be used to create complex intervals through a relatively simple command interface. For example, the processor 104 and/or the user can combine different left and right intervals through Boolean expressions to create complex intervals.

Processor 104 in stage 604 calculates the isolation measurement values based on the selected interval. In one form, processor 104 calculates the inclusiveness values (sensitivity and positive predictive values) and the exclusiveness values (specificity and negative predictive values). In alternative form, the user selects the values that are to be calculated. For example, if the user is only interested in defining the selected cluster and not distinguishing the selected cluster from the other clusters, the user through input 102 designates that only inclusiveness values should be calculated. Alternatively, if the user is only interested in distinguishing the selected cluster, the user can designate that only exclusiveness values should be calculated.

In the present example, the left interval 410 includes scores less than the cut-off value 408, and the right interval 412 includes scores greater than or equal to the cut-off value 408. Using the 0.70 cut-off value from Table 1 (data object 1, feature 1) and the left interval as a reference interval, the cluster isolation measurement values for Feature 1, Cluster A are the following:

$$\begin{matrix}Sensitivity = \frac{\begin{matrix}Number of Data Objects \\ ( Inside Interval \& Inside Cluster )\end{matrix}}{Number of Data Objects ( Inside Cluster )} \\ Sensitivity = \frac{\begin{matrix}Number of Data Objects in the \\ Left Interval From Cluster A\end{matrix}}{Number of Data Objects from Cluster A} \\ Sensitivity = \frac{0}{3} = 0 & ( 1 ) \\ \begin{matrix}Positive \\ Predictive \\ Value\end{matrix} = \frac{\begin{matrix}Number of Data Objects \\ ( Inside Interval \& Inside Cluster )\end{matrix}}{Number of Data Objects ( Inside Interval )} & ( 2 )\end{matrix}$$

After the isolation measurement values have been calculated, processor 104 in stage 606 determines if the values satisfy the threshold limits that were defined in stage 204. If the interval has isolation measurement scores that satisfy the threshold limits, processor 104 in stage 608 stores the feature, interval, and isolation measurement values in memory 106. It should be understood that the processor 104 could store only the feature in memory 106 or other combinations of information as would be desired. Further, it should be appreciated that processor 104 could store all features that satisfy the threshold limits into memory 106. This stored information is used later in stage 214 to generate the report of features that distinguish the clusters of interest. After stage 606 or 608, the processor 104 in stage 610 determines if the last viable cut-off valve has been selected. One way of determining this condition is to analyze the isolation measurement values. For example, the last viable cut-off value could occur when the sensitivity value equals 1. It should be appreciated that the last viable cut-off value can be determined in other manners, such as by using end-of-data pointers. If the last viable cut-off value has not been selected, processor 104 selects the next cut-off value in stage 602.

After the last viable cut-off value has been processed, processor 104 in stage 612 selects the best isolation measurement values from those that have been stored. In one form, the best intervals are the intervals that have the highest specificity values and have sensitivity values that at least satisfy the threshold limits. In another form, the best intervals are deemed the intervals that have the highest isolation measurement values. Processor 104 uses predefined rules to break ties by weighing cluster isolation measurements differently. For example, processor 104 could weigh inclusiveness values higher than exclusiveness values. After the feature information is selected and stored in stage 612, processor 104 in stage 614 continues to the next stage in flow chart 200.

After all the isolation feature/interval combinations have been determined, the processor 104 sends the report of distinguishing features to the output 108 in stage 214. Table 2, below, shows an exemplary output report generated in stage 214. It should be appreciated that reports containing different information and other types of reports, such as graphs, could also be generated in stage 214.

TABLE 2

| | | | | Predictive | Sensitivity/ |
|---|---|---|---|---|---|
| Cluster | Feature | Descriptor Type | Isolation Interval | Value (+/−) | Specificity |
| 0 | aaa | Right Interval | Greater than 0.027 | 1 | 0.667 |
| | eyl | Right Interval | Greater than 0.022 | 1 | 0.5 |
| | aag | Right Interval | Greater than 0.022 | 0.5 | 0.667 |
| | nnt | Left Interval | Less than 0.004 | 0.6 | 0.5 |
| | ysn | Left Interval | Less than 0.004 | 0.75 | 0.5 |
| | lnn | Left Interval | Less than 0 | 1 | 0.5 |
| | nns | Left Interval | Less than 0.001 | 1 | 0.5 |
| | ntt | Left Interval | Less than 0.004 | 1 | 0.5 |
| | sye | Left Interval | Less than 0.003 | 1 | 0.5 |
| | nnk | Left Interval | Less than 0.001 | 0.8 | 0.667 |
| | snn | Left Interval | Less than 0.001 | 0.8 | 0.667 |
| | gny | Left Interval | Less than 0.004 | 0.75 | 0.5 |
| | nys | Left Interval | Less than 0.002 | 0.75 | 0.5 |
| | knn | Left Interval | Less than 0 | 0.67 | 0.667 |
| | nss | Left Interval | Less than 0.004 | 0.67 | 0.667 |
| | yng | Left Interval | Less than 0.004 | 0.57 | 0.667 |
| 1 | gaa | Right Interval | Greater than 0.014 | 0.62 | 0.581 |
| | aag | Right Interval | Greater than 0.013 | 0.59 | 0.547 |
| | aaa | Right Interval | Greater than 0.011 | 0.51 | 0.512 |
| 3 | acp | Right Interval | Greater than 0.028 | 0.86 | 0.667 |
| | gac | Right Interval | Greater than 0.026 | 0.67 | 0.667 |
| | cpv | Right Interval | Greater than 0.022 | 0.56 | 0.556 |
| | kcv | Right Interval | Greater than 0.028 | 0.5 | 0.556 |
| | vcp | Right Interval | Greater than 0.02 | 0.5 | 0.778 |
| 4 | eee | Right Interval | Greater than 0.021 | 1 | 0.667 |
| | kae | Right Interval | Greater than 0.021 | 1 | 0.667 |
| 5 | apd | Right Interval | Greater than 0.022 | 0.94 | 0.64 |
| 6 | swi | Right Interval | Greater than 0.027 | 0.69 | 0.54 |
| | lif | Right Interval | Greater than 0.008 | 0.64 | 0.627 |
| | wli | Right Interval | Greater than 0.013 | 0.54 | 0.547 |
| | tif | Right Interval | Greater than 0.016 | 0.52 | 0.513 |
| 9 | cpt | Right Interval | Greater than 0.029 | 0.57 | 0.5 |
| | ycp | Right Interval | Greater than 0.023 | 0.5 | 0.75 |
| 10 | pkc | Right Interval | Greater than 0.03 | 0.89 | 0.5 |
| | kcg | Right Interval | Greater than 0.016 | 0.5 | 0.5 |
| 11 | crg | Right Interval | Greater than 0.024 | 1 | 0.706 |
| 12 | swi | Right Interval | Greater than 0.038 | 1 | 0.895 |
| 13 | ctg | Right Interval | Greater than 0.024 | 1 | 0.733 |
| 14 | nnt | Right Interval | Greater than 0.018 | 0.57 | 0.598 |
| 16 | edw | Right Interval | Greater than 0.027 | 0.52 | 0.516 |

As shown in Table 2, the features being described are protein sequences. The “Cluster” column shows the specific cluster membership grouping. The “Feature” column shows particular features that distinguish the corresponding cluster from the other clusters. “Descriptor Type” column describes what type of interval (left or right) distinguishes the particular feature, and the “Isolation Interval” column describes the particular interval score for the feature that distinguishes the cluster. The predictive value and specificity/sensitivity values are shown in respective columns. For example, feature “aaa” distinguishes cluster 0 for interval score greater than 0.027 and has a sensitivity of 0.667 along with a positive predictive value of 1.

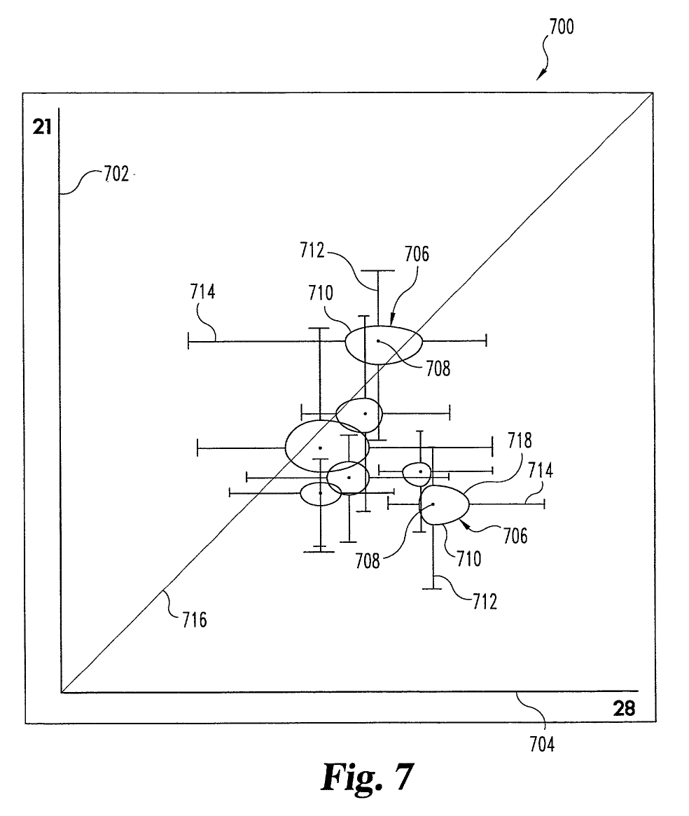

In order to quickly identify distinguishing features from large sets of clusters, the processor 104 is operable to utilize a number of data visualization techniques according to the present invention that are used to generate graphical representations of the clusters and their isolation measurement values on output 108. FIG. 7 illustrates one visualization technique, which is used to graphically distinguish clusters based on feature scores. As illustrated, two-cluster feature distribution graph 700 has a vertical cluster-feature score axis 702 and a horizontal cluster-feature score axis 704. Axes 702 and 704 represent feature scores for separate clusters. In the illustrated example, the feature scores for axis 702 are for cluster “21” and the feature scores for axis 704 are for cluster “28”. Individual features 706 are graphed based on their scores with respect to cluster axes 702 and 704. For each feature 706, a mean score 708 is plotted for both graphed features. A feature score spread perimeter 710 is used to visually represent the spread of scores for the individual features 706. In one form, the perimeter 710 is based on a range including from 25% to 75% of the features scores. As should be understood, other ranges and distribution-spread measurements can be used to plot each perimeter 710. To show the total range of feature scores for each cluster, vertical range bars 712 and horizontal range bars 714 are plotted for each feature 706. Graph 700 has a division line 716 that represents an equality of feature scores between the graphed clusters. A user can use division line 716 as a reference line to find distinguishing features 706. The farther a feature 706 is located away from division line 716, the better the feature 706 distinguishes the graphed cluster from the other graphed cluster. For example, as shown, feature 718 is relatively far away from division line 716 on the cluster axes 704 side of the division line 716. From this, it can be inferred that feature 718 can be used to distinguish cluster “28” (axis 704) from cluster “21” (axis 702).

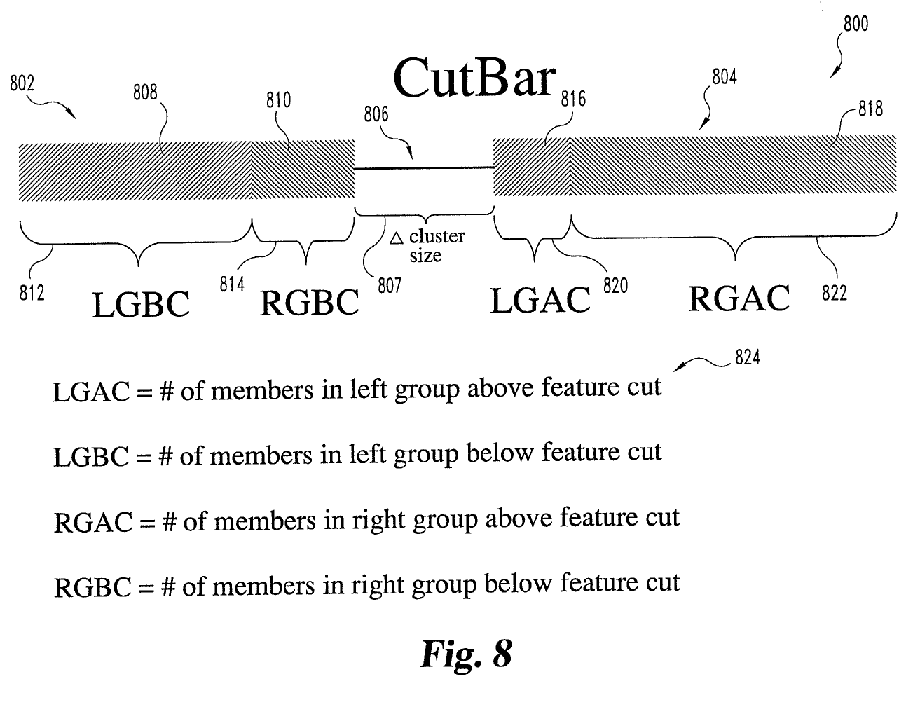

Another technique according to the present invention for visually distinguishing clusters from one another is illustrated in FIG. 8. Cut-bar graph 800 is used to visualize the inclusiveness and exclusiveness values for a given feature in order to quickly determine the feature score(s) that best distinguish pairs of clusters. A user can quickly review a large number of cut-bar graphs 800 to visually “mine” the cluster information to find distinguishing feature scores. As shown, the cut-bar graph 800 includes a below cut portion 802, an above cut portion 804, and a delta cluster size portion 806 that spans between portions 802 and 804 for a given feature. The above cut portion 804 visually represents the portions of clusters that are above a given cut-off value, and the below cut portion 804 visually represents the portions of the clusters that are below the given cut-off value. In the illustrated embodiment, the delta cluster size portion 806 is a line. Length 807 of the delta cluster size portion 806 is used to indicate the size differences between the two (left and right) cluster groups that are being compared on the cut-bar graph 800. When the length 807 of the delta cluster size portion 806 is relatively large, no conclusive cluster distinctions can be made because the cluster sizes are not substantially similar. Ideally, the length 807 of portion 806 should be relatively small so that similar clusters are compared.

The below cut portion 802 is further subdivided into a left group below cut (LGBC) bar 808 and a right group below cut (RGBC) bar 810. Length 812 of the LGBC bar 808 is proportionally sized to represent the number of data objects in the left cluster group that are below (less than/less than or equal to) the cut-off value, and length 814 of the RGBC bar 810 is proportionally sized to represent the number of data objects in the right group that are below the cut-off value. In a similar manner to the below-cut portion 802, the above cut portion 804 is further subdivided into a left group above cut (LGAC) bar 816 and a right group above cut (RGAC) bar 818. Length 820 of the LGAC bar 816 is proportionally sized to represent the number of data objects in the left cluster group that are above (greater than/greater than or equal to) the cut-off value, and length 822 of the RGAC bar 818 is proportionally sized to represent the number of data objects in the right cluster group that are above the cut-off value. Graph 800 further includes a legend 822 that is used to identify the different portions of graph 800. In graph 800, a distinguishing cut-off value, which has high inclusiveness and exclusiveness values, has a relatively large LGBC bar 808 and RGAC bar 818 along with a relatively small RGBC bar 810 and LGAC bar 816. A non-distinguishing cut-off value in graph 800 has relatively large RGBC 810 and LGAC 816 bars. Using these guidelines, a user can quickly review large numbers of graphs 800 to quickly find distinguishing features and cut-off values.

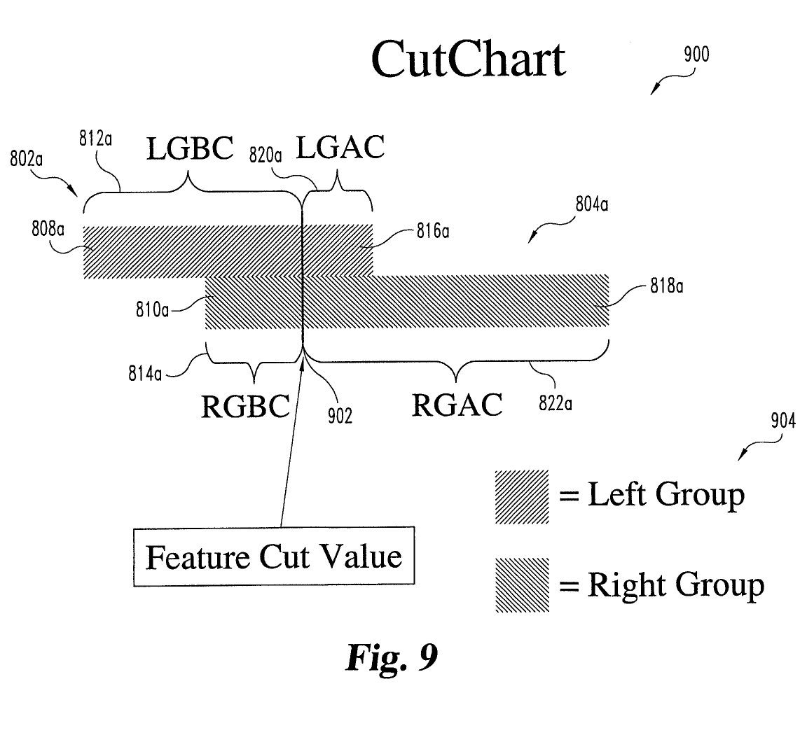

A further technique according to the present invention for visually distinguishing clustered data objects is illustrated in FIG. 9. As shown, cut-chart graph 900 displays information similar to the cur-bar graph 800, but displays the information in a slightly different manner. Cut-chart graph 900 has a cut-off value line 902 that horizontally divides the graph 900 into two portions, a below cut portion 802a and an above cut portion 804a. The below cut portion 802a is further subdivided into a LGBC bar 808a and a RGBC bar 810a. Length 812a of the LGBC bar 808a is proportionally sized to represent the number of data objects in the left cluster group below the cut-off value, and length 814a of the RGBC bar 810a is proportionally sized to represent the number of data objects in the right cluster group below the cut-off value. In comparison, the above cut portion 804a is further subdivided into a LGAC bar 816a and a RGAC bar 818a. Length 820a of the LGAC bar 816a is proportionally sized to represent the number of data objects in the left cluster group above the cut-off value, and length 822a of the RGAC bar 818a is proportionally sized to represent the number of data objects in the right cluster group above the cut-off value. Legend 904 identifies the particular clusters shown in graph 900. The cut-chart graph 900 is analyzed in similar fashion to the cut-bar graph 800. A distinguishing cut-off value for a graphed feature has relatively large LGBC 808a and RGAC 818a bars, and relatively small RGBC 810a and LGAC 816a bars. A non-distinguishing cut-off value in graph 900 has relatively large RGBC 810a and LGAC 816a bars.

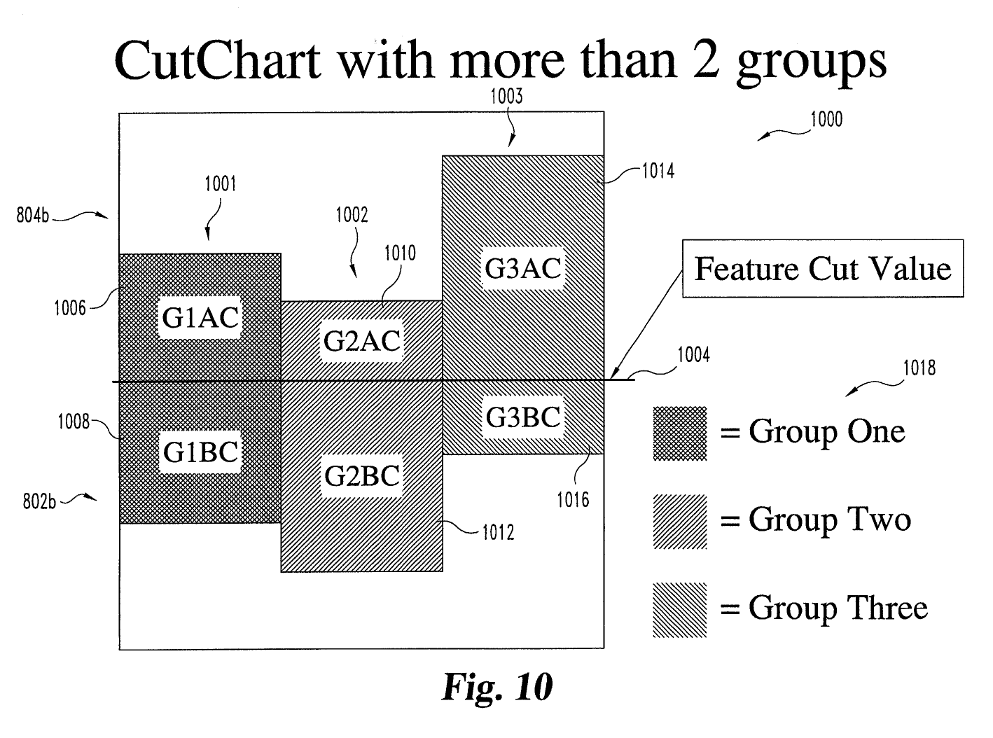

In another technique, multiple clusters are visually analyzed using cut-chart graph 1000 (FIG. 10). As illustrated, cluster group bars 1001, 1002 and 1003, which respectively represent first, second and third clusters, are positioned next to one another. A cut-off value line 1004 vertically divides graph 1000 into a below cut portion 802b and an above cut portion 804b. Bars 1001, 1003 and 1003 are positioned and sized to represent cluster distributions in relation to the cut-off value, which is represented by the cut-off value line 1004. The first group bar 1001 is positioned relative to the cut-off line 1004 such that the number of first group members above the cut-off value are represented by group one above cut (G1AC) portion 1006 and the number of first group members below the cut-off value are represented by group one below cut (G1BC) portion 1008. Likewise, bar 1002 has an above cut portion (G2AC) 1010 along with a below cut portion (G2BC) 1012, and bar 1003 has an above cut portion (G3AC) 1014 along with a below cut portion (G3BC) 1016. As should be appreciated, cut-chart graph 1000 can be modified to include more cluster bars than the three bars shown. Cut-chart graph 1000 is analyzed in a similar fashion to the techniques as described above. A cluster is distinguished when a large portion of its bar is on one side of the cut-off line 1004 and large portions of the other cluster bars are located on the other side of the cut-off line 1004. By representing the cluster distributions as bars, as opposed to distribution curves, a user can quickly analyze a relatively large number of clusters at the same time.

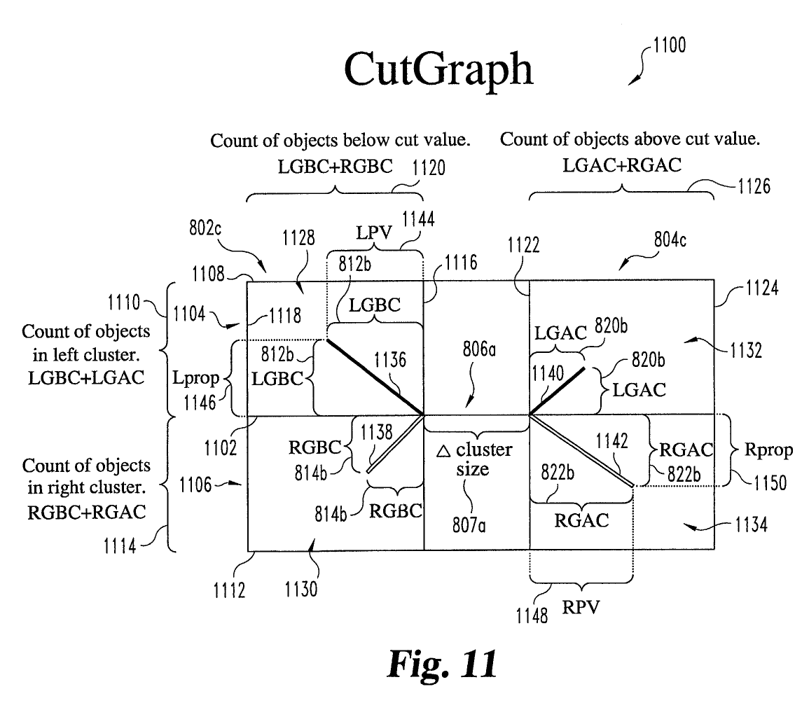

Another technique for visually distinguishing clusters of data objects according to the present invention is illustrated in FIG. 11. Processor 104 generates cut-graph 1100 on output 108 for a particular cut-off value and feature combination. As shown, cut-graph 1100 includes a division line 1102 that vertically divides the graph 1100 into an upper portion 1104 and a lower portion 1106. The upper portion 1104 is bounded by a left cluster count indicator line 1108, and line 1108 is proportionally spaced a distance 1110 from division line 1102 to represent the total quantity of data objects in the left cluster (LGBC+LGAC). The lower portion 1106 is bounded by a right cluster count indicator line 1112. Line 1112 is proportionally spaced a distance 1114 from division line 1102 to represent the total quantity of data objects in the right cluster (RGBC+RGAC). The cut-graph 1100 further has a below cut portion 802c, an above cut portion 804c, and a delta cluster size portion 806a that spans between portions 802c and 804c for the graphed feature. Length 807a of the delta cluster size portion 806a is sized proportional to the relative population differences between the graphed clusters. Ideally, this length 807a should be relatively small so that only similarly sized clusters are distinguished. Below cut portion 802c is bounded by below cut division line 1116 and below cut count indicator line 1118. Length 1120 of the below cut portion 802c is proportionally sized to represent the quantity of data objects below the cut-off value (LGBC+RGBC). Above cut portion 804c is bounded by above cut division line 1122 and above cut count indicator line 1124, and length 1126 of the above cut portion 804c is proportionally sized to represent the quantity of data objects above the cut-off value.

The below cut portion 802c is subdivided into a LGBC quadrant 1128 and a RGBC quadrant 1130. Similarly, the above cut portion 804c is subdivided into a LGAC quadrant 1132 and a RGAC quadrant 1134. In the LGBC quadrant 1128, a LGBC vector (bar/line) 1136 extends from the intersection of lines 1102 and 1116, and terminates at a LGBC distance 812b that is equidistant from both lines 1102 and 1116. The LGBC distance 812b is proportionally sized to represent the number of left cluster group members below the cut-off value. As shown in the RGBC quadrant 1130, a RGBC vector (bar/line) 1138 terminates at a RGBC distance 814b from lines 1102 and 1116. The RGBC distance 814b is proportionally sized to represent the number of right cluster group members below the cut-off value. In the LGAC quadrant 1132, a LGAC vector (bar) 1140 extends at a LGAC distance 820b from both lines 1102 and 1122. The LGAC distance 820b is proportional to the number of left group cluster members that are above the cut-off value. A RGAC vector (bar) 1142 extends at a LGAC distance 820b from both lines 1102 and 1122 in RGAC quadrant 1134.

A distinguishing cut-off value for a feature is visually represented with vectors 1136 and 1142 being relatively long, and vectors 1138 and 1140 being relatively short. This vector relationship is indicative of high inclusiveness and exclusiveness values. In addition, the length 807a of portion 806a should be small so that only similarly sized clusters are distinguished. If vectors 1138 and 1140 are relatively long then the cut-off value does not distinguish the graphed clusters. The vectors in the cut-graph 1100 further allow for the visualization of the inclusiveness and exclusiveness values of each graphed cluster. LGBC vector 1136 when compared to length 1120, which is shown by LPV portion 1114, represents the positive predictive value for the left cluster. Further, the LGBC vector 1136 when compared to length 1110, which is shown by left group proportion (Lprop) portion 1146, represents the sensitivity value for the left cluster group. Comparing the RGAC vector 1142 with the length 1126 indicates the negative predictive value for the left cluster, which is indicated by right predictive value (RPV) portion 1148. Comparing the RGAC vector 1142 with length 1114, which represented by right proportion (Rprop) portion 1150, represents the specificity value for the left cluster.

It should be understood that the above-described cluster isolation method and system can be used in a large number of data analysis applications. By way of non-limiting example, the method and system can be used for data mining/warehousing and information visualization. Further, the cluster isolation method can be used in investigations for grouping data objects based on their similarity. For example, the method can be used in gene expression studies, sensory studies to determine consumer likes/dislikes of products (food or drink studies), and material classification for archeological studies. Other genomic and bioinformatic processing can also benefit. Further, this technology can be applied to data processing for pattern recognition.

While specific embodiments of the present invention have been shown and described in detail, the breadth and scope of the present invention should not be limited by the above described exemplary embodiments, but should be defined only in accordance with the following claims and their equivalents. All changes and modifications that come within the spirit of the invention are desired to be protected.

What is claimed is:

1. A method, comprising:
selecting a number of items of a common type for analysis;
representing each of the items as a corresponding one of a number of data objects with a computer system, the data objects being grouped into a number of clusters based on relative similarity;
evaluating the clusters with the computer system in order to distinguish a selected cluster: (a) setting at least one limit; (b) designating the selected cluster for evaluation; (c) selecting an interval of feature scores for a feature; and (d) determining with the computer system that an inclusiveness value for the feature satisfies the limit and an exclusiveness value for the feature satisfies the limit, the inclusiveness value corresponding to a proportion of data objects from the selected cluster within the interval, the exclusiveness value corresponding to a proportion of data objects from one or more other clusters outside the interval; and
providing results of said determining with an output device of the computer system.

2. The method of claim 1, wherein the data objects each represent at least one gene sequence.

3. The method of claim 1, wherein the data objects each represent a document.

4. The method of claim 1, wherein said setting includes receiving from a user of the computer system inputs corresponding to the limit, and wherein said designating includes receiving from the user of the computer system an input corresponding to a selection of the selected cluster.

5. The method of claim 1, wherein the limit is predefined by the computer system.

6. The method of claim 1, wherein the interval includes values less than a cut-off value.

7. The method of claim 1, wherein the interval includes values greater than a cut-off value.

8. The method of claim 1, wherein the inclusiveness value includes a sensitivity value that corresponds to a proportion including number of data objects from the selected cluster within the interval divided by number of data objects from the selected cluster, and wherein the exclusiveness value includes a specificity value that corresponds a proportion including number of data objects from the other clusters outside the interval divided by number of data objects from the other clusters.

9. The method of claim 1, wherein the inclusiveness value includes a positive predictive value that corresponds to a proportion including number of data objects from the selected cluster within the interval divided by number of data objects inside the interval, and wherein the exclusiveness value includes a negative predictive value that corresponds a proportion including number of data objects from the other clusters outside the interval divided by number of data objects outside the interval.

10. The method of claim 1, wherein said selecting the interval includes picking the interval based on a feature score of one of the data objects from the selected cluster.

11. The method of claim 1, wherein said providing includes displaying to a user of the computer system the interval, the inclusiveness value, the exclusiveness value, and the feature.

12. The method of claim 1, wherein said providing includes graphically representing the inclusiveness value and the exclusiveness value.

13. The method of claim 12, wherein said graphically representing includes showing for the feature a cut-bar chart that includes a first bar proportionally sized to represent a total quantity of data objects within the interval and a second bar proportionally sized to represent a total quantity of data objects outside the interval, the first bar including a portion proportionally sized to represent a quantity of data objects from the selected cluster within the interval, and the second bar including a portion proportionally sized to represent a quantity of data objects from the selected cluster outside the interval.

14. The method of claim 13, wherein the cut-bar chart further includes a delta cluster size portion that is proportionally sized to represent a difference in cluster size between the selected cluster and at least one of the other clusters.

15. The method of claim 12, wherein said graphically representing includes showing a cut-chart for the feature, the cut-chart including a cut value indicator that represents a limit for the interval, a first bar that is proportionally sized to represent a total quantity of data objects in the selected cluster, and a second bar that is proportionally sized to represent a total quantity of data objects in a second cluster from the other clusters, wherein the cut value indicator demarcates an inside interval portion of the cut-chart from an outside interval portion of the cut-chart, the first bar having a portion proportionally sized in the inside interval portion to represent a quantity of data objects from the selected cluster inside the interval and a portion proportionally sized in the outside interval portion to represent a quantity of data objects from the selected cluster outside the interval, the second bar having a portion proportionally sized in the inside interval portion to represent a quantity of data objects from the second cluster inside the interval and a portion proportionally sized in the outside interval portion to represent a quantity of data objects from the second cluster outside the interval.

16. The method of claim 15, wherein the cut-chart includes a third bar that is proportionally sized to represent a total quantity of data objects from a third cluster.

17. The method of claim 12, wherein said graphically representing includes showing a cut-graph for the feature, the cut-graph including a vector proportionally sized to represent the quantity of data objects from the selected cluster inside the interval and a vector representing a quantity of data objects in a second cluster that is outside the interval.

18. The method of claim 12, wherein said graphically representing includes showing a two-cluster feature distribution graph in which each feature is represented by a feature score spread perimeter.

19. The method of claim 1, wherein the inclusiveness value satisfies the limit by being at least equal to the limit, and the exclusiveness value satisfies the limit by being at least equal to the limit.

20. The method of claim 1, further comprising:
collecting data for the items; and
entering the data into the computer system.

21. A computer-readable device, the device comprising:
logic executable by a computer system to distinguish a selected cluster of data objects, said logic being further executable by said computer system to calculate for the selected cluster an inclusiveness value and an exclusiveness value for a feature, wherein the inclusiveness value corresponds to a proportion of data objects from the selected cluster within the interval, the exclusiveness value corresponds to a proportion of data objects from one or more other clusters outside the interval; and
wherein said logic is operable by said computer system to provide results when the inclusiveness value and the exclusiveness value satisfy at least one limit.

22. The device of claim 21, wherein the device includes a removable memory device and said logic is in a form of a number of programming instructions for said computer system stored on said removable memory device.

23. The device of claim 21, wherein the device includes at least a portion of a computer network and said logic is in a form of signals on said computer network encoded with said logic.

24. A data processing system, comprising:
memory operable to store a number of clusters of data objects that are grouped based on relative similarity;
a processor operatively coupled to said memory, said processor being operable to distinguish a selected cluster, said processor being further operable to calculate for the selected cluster an inclusiveness value and an exclusiveness value for a feature, wherein the inclusiveness value corresponds to a proportion of data objects from the selected cluster within the interval, the exclusiveness value corresponds to a proportion of data objects from one or more other clusters outside the interval; and
an output device operatively coupled to said processor, said output device being operable to provide results from said processor when the inclusiveness value and the exclusiveness value satisfy at least one limit.

25. The data processing system of claim 24, further comprising an input device operatively coupled to said processor to enter data for the data objects.

26. The data processing system of claim 24, wherein said output device includes a display.

27. A method, comprising:
selecting a number of items of a common type for analysis;
representing each of the items as a corresponding one of a number of data objects with a computer system, the data objects being grouped into a number of clusters based on relative similarity; and
generating a graph on an output device of the computer system in order to distinguish a selected cluster, wherein the graph includes a first portion proportionally sized to represent a quantity of data objects within an interval of feature scores for a feature and a second portion proportionally sized to represent a quantity of data objects outside the interval for the feature, the first portion including a bar proportionally sized to represent a quantity of data objects from the selected cluster within the interval, and the second portion including a bar proportionally sized to represent a quantity of data objects from the selected cluster outside the interval.

28. The method of claim 27, wherein the graph includes a cut-bar graph having a delta cluster size portion provided between the first portion and the second portion, the delta cluster size portion being proportionally sized to represent a difference in population size between the selected cluster and one or more other clusters.

29. The method of claim 27, wherein the graph includes a cut-chart graph having an interval cut-off line demarcating the first portion and the second portion.

30. The method of claim 27, wherein the graph includes a cut-graph having a delta cluster size portion proportionally sized to represent a difference in population size between the selected cluster and one or more other clusters.
